(19) United States
(12) Patent Application Publication
(10) Pub. No.: US 2026/0153198 A1
(43) Pub. Date: Jun. 4, 2026

(54) METHOD FOR DETERMINING THE INITIAL PRESSURE IN A PRESSURIZED GAS TANK TO BE FILLED FROM A DISPENSING STATION

(71) Applicant: L'Air Liquide, Societe Anonyme pour l'Etude et l’Exploitation des Procedes Georges Claude, Paris (FR)

(72) Inventors: Tom RONY, Paris (FR); Margo SIMON, Paris (FR)

(21) Appl. No.: 19/403,925

(22) Filed: Nov. 30, 2025

(30) Foreign Application Priority Data
Dec. 2, 2024 (FR) FR2413295

(51) Int. Cl. F17C 13/02; F17C 5/00

(52) U.S. Cl. CPC F17C 13/025; F17C 5/002; F17C 2205/0323; F17C 2205/0352; F17C 2205/037; F17C 2227/0302; F17C 2250/043; F17C 2250/0439; F17C 2250/0443; F17C 2250/0626; F17C 2260/022; F17C 2260/023

(57) ABSTRACT

Method for determining the initial pressure of a pressurized gas tank to be filled from a dispensing station, the dispensing station comprising a filling line including in series a pressurized gas source, a heat exchanger, and a dispenser, the dispensing station also comprising a bypass line on the filling line around the heat exchanger, the method comprising the following steps: a step of transferring a gas flow from the gas source or the heat exchanger to the dispenser via the bypass line, a step of reading an initial pressure in the tank to be filled as a function of a pressure measured on the filling line.

### CROSS REFERENCE TO RELATED APPLICATIONS

This application claims the benefit of priority under 35 U.S.C. § 119 (a) and (b) to French patent application No. FR2413295, filed Dec. 2, 2024, which is herein incorporated by reference in its entirety.

### FIELD OF THE INVENTION

The invention relates to a method for determining the initial pressure in a pressurized gas tank to be filled from a dispensing station. The pressurized gas may be hydrogen.

### BACKGROUND OF THE INVENTION

Before filling a tank with pressurized gas from a dispensing station, the initial pressure of the residual gas in this tank to be filled must be known. The datum relating to the initial pressure is used to adjust the filling parameters and in particular to prevent overfilling or overheating, which may affect the integrity of the tank to be filled and endanger the user.

Various different methods are used to determine the initial pressure in a tank to be filled. Two are described in document US2016010799A in relation to a dispensing station comprising a transfer line that connects a pressurized gas storage tank, a heat exchanger and a dispenser.

In particular, the filling line is provided notably with a flow meter and a pressure controller upstream of the heat exchanger. Furthermore, the filling line is provided with a regulating valve downstream of the heat exchanger. This valve can be bypassed via a bypass line of the filling line.

Thus, to determine the initial pressure of the gas in the tank to be filled, a first method comprises a step of sending a gas flow from the storage to the dispenser via the flow meter, the pressure controller and the heat exchanger of the filling line. According to this first method, the opening of the pressure controller is gradually changed to increase the pressure in the filling line. The pressure at which a flow rate is recorded by the flow meter represents the initial pressure of the tank.

This first method therefore requires a pressure controller and a valve which are compatible with very low flow rates. Furthermore, the valve must be configured at the same time to allow higher flow rates.

It is difficult to find a valve that allows high flow rates while being capable of finely regulating low flow rates at low pressure. This is a limitation of the first method.

A second method comprises a step of sending a gas flow from the storage to the dispenser via the heat exchanger and the bypass line. To do this, the valve located on the bypass line is first opened and then closed after a few seconds.

While the valve is open, a pressure increase-decrease cycle occurs in the heat exchanger. Such cycles are detrimental to the service life of the heat exchanger.

### SUMMARY OF THE INVENTION

An objective of certain embodiments of the invention is to overcome the drawbacks listed above at least in part and to propose a method which is simple to implement.

For this purpose, according to a first aspect, the invention relates to a method for determining the initial pressure of a pressurized gas tank to be filled from a dispensing station.

In particular, the dispensing station comprises a filling line including in series a pressurized gas source, a heat exchanger and a dispenser. The dispensing station also comprises a bypass line on the filling line around the heat exchanger.

The method comprises the following steps: a step of transferring a gas flow from the source or from the exchanger to the dispenser via the bypass line, and a step of reading an initial pressure in the tank to be filled as a function of a pressure measured on the filling line.

Typically, the gas flow transferred during the transfer step passes entirely through the bypass line, so that no part of this flow passes through the heat exchanger.

Furthermore, embodiments of the invention may have one or more of the following features:
the bypass line has a first end connected to the filling line at a first junction point located upstream of the heat exchanger and a second end connected to the filling line at a second junction point located downstream of the heat exchanger,
the bypass line comprises a system for regulating the flow rate and/or pressure of the flow,
the flow and/or pressure regulation system comprises a regulating valve and optionally a throttle zone preferably located downstream of the regulating valve,
the bypass line is formed from a duct of constant cross-section,
the throttle zone comprises a calibrated orifice arranged in the duct,
the bypass line is formed by a duct including a central portion of reduced cross-section and two end portions of cross-section greater than a cross-section of the central portion,
the central portion of the duct forms the throttle zone,
the filling line comprises a first circuit connecting the gas source to an inlet of the heat exchanger,
the first circuit is provided with a first valve and/or a flow meter,
the first circuit is provided with a pressure controller,
the first circuit is provided with a first pressure sensor,
the first valve and the flow meter are arranged upstream of the first junction point,
the pressure controller and the first pressure sensor are located downstream of the first junction point,
the filling line comprises a second circuit connecting an outlet of the heat exchanger to the dispenser,
the second circuit is provided with a second valve,
the second circuit is provided with a second pressure sensor,
the second circuit is provided with a temperature sensor,
the second valve is arranged upstream of the second junction point,
the temperature sensor and the second pressure sensor are arranged downstream of the second junction point,
the method comprises a step of monitoring an increase in the gas pressure in the filling line to a first value,
the method comprises a step of monitoring a decrease in the pressure in the filling line to a second value, the second value being lower than the first value,
the step of reading the initial pressure in the tank to be filled comprises an operation of identifying the initial pressure at the second value measured in the filling line,
the method comprises a step of balancing a pressure in the heat exchanger with a pressure of the tank to be filled.

According to a second aspect, the invention relates to a dispensing station for a pressurized gas. The dispensing station comprises a filling line including in series a pressurized gas source, a heat exchanger, and a dispenser. Furthermore, the dispensing station comprises a bypass line on the filling line around the heat exchanger.

According to this second aspect of the invention, the dispensing station comprises an electronic component configured to control a transfer of a gas flow from the gas source or the heat exchanger to the dispenser via the bypass line. The electronic component is also configured to determine an initial pressure in the tank to be filled as a function of a pressure measured on the filling line.

Advantageously, the electronic component is also configured to calculate a final pressure in the tank as a function of the initial pressure.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Other specific features and advantages will become apparent upon reading the description below, which is provided with reference to the following figures, in which: FIG. 1 is a schematic view illustrating a dispensing station for a pressurized gas according to the invention, the station comprising a filling line connecting a gas source, a heat exchanger and a dispenser, the station also comprising a bypass line on the filling line around the heat exchanger.

FIG. 2 illustrates steps of a method according to the invention for determining the initial pressure in a tank to be filled, from the dispensing station illustrated in FIG. 1.

FIG. 3 illustrates a change in the pressure in the heat exchanger when determining, using a method from the prior art, the initial pressure in a tank to be filled.

FIG. 4 illustrates a change in the pressure in the heat exchanger when determining, using the method according to the invention, the initial pressure in a tank to be filled.

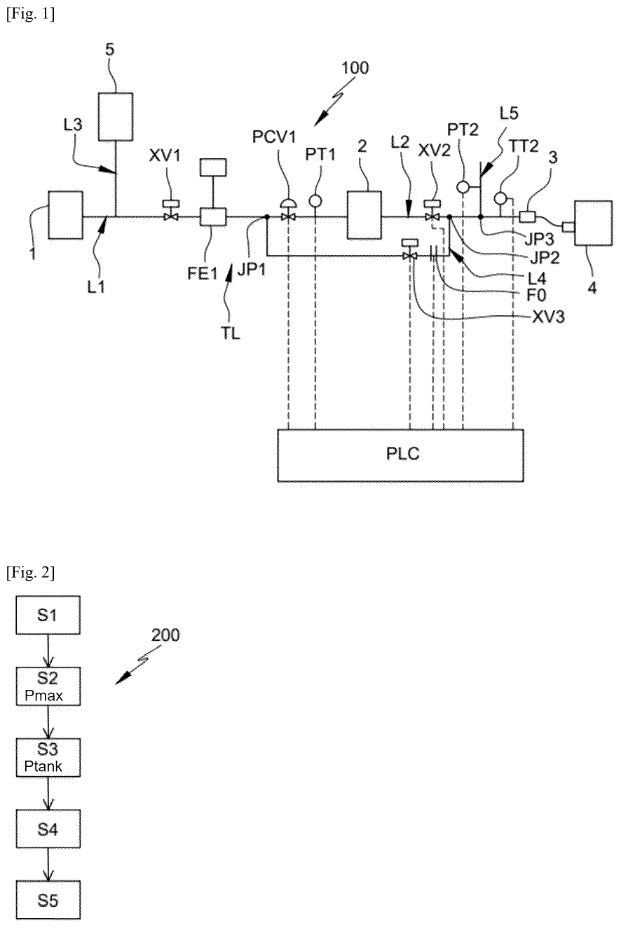

### DETAILED DESCRIPTION OF THE INVENTION

FIG. 1 illustrates a dispensing station 100 for a pressurized gas according to the invention.

The dispensing station 100 comprises a filling line TL including in series a pressurized gas source 1, a heat exchanger 2, and a dispenser 3 intended to receive a tank 4 to be filled.

In more detail, the filling line TL comprises a first circuit L1 connecting the gas source 1 to an inlet of the heat exchanger 2, and a second circuit L2 connecting an outlet of the heat exchanger 2 to the dispenser 3.

In particular, the first circuit L1 is provided with a pressure controller PCV1. The pressure controller PCV1 is configured to regulate the outlet pressure of the dispenser 3 and the pressure of the heat exchanger 2.

The first circuit L1 may also be provided with a first valve XV1, a flow meter FE1 and a first pressure sensor PT1.

The second circuit L2 is provided with a second valve XV2. The second valve XV2 is configured to fluidically connect the heat exchanger 2 to the tank 4 to be filled. Furthermore, the second valve XV2 is configured to balance a pressure of the heat exchanger 2 with a pressure of the tank 4 to be filled.

The second circuit L2 can also be provided with a second valve XV2, a second pressure sensor PT2 and a temperature sensor TT2.

The dispensing station 100 may also comprise a pressurized gas storage tank 5 connected to the filling line TL by a third circuit L3. In particular, the third circuit L3 is connected to the first circuit L1 upstream of the first valve XV1.

The dispensing station 100 also comprises a bypass line L4 on the filling line TL around the heat exchanger 2, and a purge line L5 of the filling line TL.

In particular, the bypass line L4 has a first end connected to the filling line TL at a first junction point JP1 located upstream of the heat exchanger 2. The bypass line L4 also has a second end connected to the filling line TL at a second junction point JP2 located downstream of the heat exchanger 2.

When the pressure controller PCV1 and the second valve XV2 are closed, it is possible to isolate the heat exchanger 2 and direct the entire gas flow to the bypass line L4.

Furthermore, the bypass line L4 comprises a system for regulating the flow rate and/or pressure of a gas flow passing therethrough. This flow rate and/or pressure regulation system comprises a regulating valve XV3. This regulation system may also comprise a throttle zone FO. The throttle zone FO is located downstream of the regulating valve XV3.

Finally, the bypass line L4 can be formed from a duct of constant cross-section. In this case, the throttle zone FO may be constituted by a calibrated orifice arranged in the duct. In a variant, the bypass line L4 may be formed from a duct comprising a central portion of reduced cross-section and two end portions of cross-section greater than the cross-section of the central portion. In this case, the central portion of reduced cross-section forms the throttle zone FO.

It should be noted that the first valve XV1 and the flow meter FE1 of the first circuit L1 are arranged upstream of the first junction point JP1. The pressure controller PCV1 and the first pressure sensor PT1 of the first circuit L1 are located downstream of the first junction point JP1.

It should also be noted that the second valve XV2 of the second circuit L2 is arranged upstream of the second junction point JP2. The temperature sensor TT2 of the second circuit L2 is arranged downstream of the second junction point JP2.

The purge line L5 is connected to the second circuit L2 at a third junction point JP3. In the example shown, the third junction point JP3 is located between the second valve XV2 and the temperature sensor TT2. Furthermore, in the example illustrated, the purge line L5 bears the second pressure sensor PT2.

According to a first aspect of the invention, the dispensing station 100 comprises an electronic component PLC configured to control a transfer of a gas flow from the gas source, or the tank 5, or the heat exchanger 2 to the dispenser 3 via the bypass line L4. The electronic component PLC is also configured to determine an initial pressure in the tank 4 to be filled from a pressure measured by the second pressure sensor PT2.

Advantageously, the electronic component PLC is configured to calculate a final pressure in the tank 4 as a function of the initial pressure.

To determine the initial pressure in a tank 4 to be filled from a dispensing station 100 described above, the invention introduces a method 200 described below.

The method 200 comprises a step S1 of transferring a gas flow from the gas source 1, or the storage tank 5 or the heat exchanger 2 to the dispenser 3 via the bypass line L4. The method 200 also comprises a step S4 of reading the initial pressure in the tank 4 to be filled as a function of the pressure recorded in the filling line TL.

In particular, the transfer of a gas flow from the heat exchanger 2 to the dispenser 3 via the bypass line L4 enables a portion of the gas in the heat exchanger 2 to be discharged. Moreover, such a transfer makes it possible to prevent surges in the tank 4 after it has been connected to the dispenser 3.

There is a risk of surges in the tank 4 to be filled notably if the pressure of this tank 4 before it is connected to the dispenser 3 is lower than the pressure of the heat exchanger 2.

It should be noted that the transfer of a gas flow from the heat exchanger 2 to the dispenser 3 via the bypass line L4 is controlled by the pressure controller PCV1.

Advantageously, the method 200 may comprise a step S2 of monitoring an increase in the gas pressure in the filling line TL to a first value Pmax. Similarly, the method 200 may comprise a step S3 of monitoring a decrease in the pressure in the filling line TL from the first value Pmax to a second value Ptank.

The second value Ptank is less than the first value Pmax. Furthermore, the second value Ptank indicates the initial pressure in the tank 4 to be filled.

Advantageously, the step S2 of monitoring the increase in pressure and the step S3 of monitoring the decrease in pressure in the filling line TL are executed using data supplied by the second pressure sensor PT2 positioned on the second circuit L2.

Advantageously, the method 200 may comprise a step S5 of balancing a pressure of the heat exchanger 2 with a pressure of the tank 4 to be filled. To do this, the second valve XV2 of the second circuit L2 is open.

After the balancing step S5, an actual filling step can take place. As mentioned above, the pressure controller PCV1 regulates the outlet pressure of the dispenser 3 during this filling step.

At the end of the filling step, and in order to prevent thermal expansion in the heat exchanger 2, the method 200 may comprise a step of conditioning the heat exchanger 2. During this step, the pressure in the heat exchanger 2 is lowered to a predefined threshold value, for example 500 bar, before a new cycle of steps S1-S4.

By directing the gas flow via the bypass line L4 around the heat exchanger 2 to determine the initial pressure in a tank 4 to be filled, the method 200 according to the invention prevents a pressure increase-drop cycle in this heat exchanger 2. The method thus prevents fatigue in the material of the exchanger 2 associated with such a pressure increase-drop cycle.

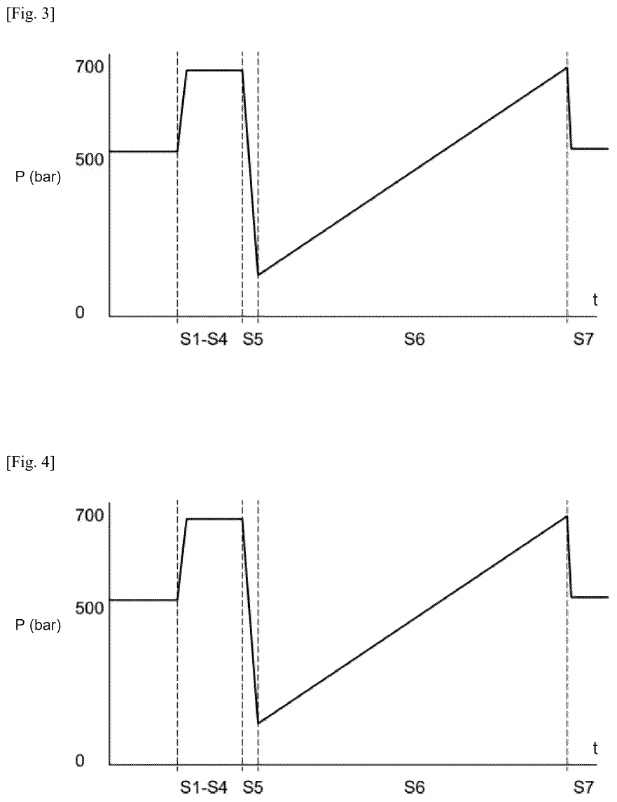

FIG. 3 and FIG. 4 each show the change in the pressure in the heat exchanger 2 during a flow transfer from the gas source 1 or the storage tank 5 to the dispenser 3. In the case in FIG. 3, the flow passes through the heat exchanger 2. In the case in FIG. 4, the flow bypasses the heat exchanger 2 via the bypass line L4.

In both cases, the change in pressure in the heat exchanger 2 is recorded during steps S1-S4 for determining the initial pressure in the tank 4, but also during the step S6 of actually filling the tank 4, and during the step of conditioning the heat exchanger 2.

It can be seen that in the first case illustrated in FIG. 3, the pressure in the heat exchanger 2 increases and then stabilizes during steps S1-S4 before decreasing during the balancing step S5.

On the other hand, in the second case illustrated in FIG. 4, the pressure in the heat exchanger 2 remains stable during steps S1-S4. This stable change during steps S1-S4 is made possible by bypassing the heat exchanger 2.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

We claim:

1. A method for determining an initial pressure of a pressurized gas tank to be filled from a dispensing station, the dispensing station comprising a filling line including, in series, a pressurized gas source, a heat exchanger, and a dispenser, the dispensing station also comprising a bypass line on the filling line that is configured to bypass the heat exchanger,
the method comprising the steps of:
a step of transferring a gas flow from the gas source or the heat exchanger to the dispenser via the bypass line; and
a step of reading an initial pressure in the tank to be filled as a function of a pressure measured on the filling line, the pressure in the heat exchanger being stable during said steps when the gas flow is bypassing the heat exchanger via the bypass line.

2. The method as claimed in claim 1, further, comprising monitoring an increase in the pressure of the gas in the filling line to a first value; and monitoring a decrease in the pressure in the filling line to a second value, the second value being less than the first value.

3. The method as claimed in claim 2, wherein the step of reading the initial pressure in the tank to be filled comprises an operation of identifying the initial pressure at the second value measured in the filling line.

4. The method as claimed in claim 1, further comprising balancing a pressure in the heat exchanger with a pressure of the tank to be filled.

5. A dispensing station for a pressurized gas tank, the dispensing station comprising:
a filling line including, in series, a pressurized gas source, a heat exchanger, and a dispenser, the dispensing station also comprising a bypass line on the filling line that is configured to bypass the heat exchanger,
wherein the filling line comprises a first circuit connecting the gas source to an inlet of the heat exchanger, the first circuit being provided with a pressure controller, and a second circuit connecting an outlet of the heat exchanger to the dispenser, the second circuit being provided with a second valve, and
an electronic component configured to control a transfer of a gas flow from the gas source or the heat exchanger to the dispenser via the bypass line,
wherein the electronic component is also configured to determine an initial pressure in the tank to be filled as a function of a pressure measured on the filling line.

6. The dispensing station as claimed in claim 5, wherein the electronic component is also configured to calculate a final pressure in the tank as a function of the initial pressure.

7. The dispensing station as claimed in claim 5, wherein the bypass line has a first end connected to the filling line at a first junction point located upstream of the heat exchanger, and a second end connected to the filling line at a second junction point located downstream of the heat exchanger.

8. The dispensing station as claimed in claim 5, wherein the bypass line comprises a system for regulating the flow rate and/or pressure of the gas flow.

9. The dispensing station as claimed in claim 8, wherein the flow rate and/or pressure regulation system comprises a regulating valve, and optionally a throttle zone preferably located downstream of the regulating valve.

10. The dispensing station as claimed in claim 9, wherein the bypass line is formed by a duct of constant cross-section, the throttle zone comprising a calibrated orifice arranged in the duct.

11. The dispensing station as claimed in claim 9, wherein the bypass line is formed by a duct including a central portion of reduced cross-section and two end portions of cross-section greater than a cross-section of the central portion, the central portion forming the throttle zone.

12. The dispensing station as claimed in claim 5, wherein the first circuit is provided with a first valve, a flow meter and a first pressure sensor.

13. The dispensing station as claimed in claim 7, wherein the first circuit is provided with a first valve, a flow meter and a first pressure sensor, wherein the first valve and the flow meter are arranged upstream of the first junction point, the pressure controller and the first pressure sensor being located downstream of the first junction point.

14. The dispensing station as claimed in claim 5, wherein the second circuit is provided with a second pressure sensor and/or a temperature sensor.

15. The dispensing station as claimed in claim 7, wherein the second circuit is provided with a second pressure sensor and/or a temperature sensor, wherein the second valve is arranged upstream of the second junction point, the temperature sensor and the second pressure sensor being arranged downstream of the second junction point.
